(19) United States
(12) Patent Application Publication
(10) Pub. No.: US 2026/0087960 A1
(43) Pub. Date: Mar. 26, 2026

(54) Electronic Display Image Sticking Compensation

(71) Applicant: Apple Inc., Cupertino, CA (US)

(72) Inventors: Hyunsoo Kim, San Diego, CA (US); Hyunwoo Nho, Palo Alto, CA (US); Jie Won Ryu, San Jose, CA (US); SeyedAli TaheriTari, San Jose, CA (US); Tae-Wook Koh, San Jose, CA (US); Wei Xiong, Mountain View, CA (US); Weichuan Yao, San Diego, CA (US); Yao Shi, Sunnyvale, CA (US)

(21) Appl. No.: 19/338,951

(22) Filed: Sep. 24, 2025

Related U.S. Application Data
(60) Provisional application No. 63/698,290, filed on Sep. 24, 2024.

(51) Int. Cl. G09G 3/20

(52) U.S. Cl. CPC G09G 3/2007; G09G 2320/0257; G09G 2320/06; G09G 2320/103; G09G 2340/0435; G09G 2360/18

(57) ABSTRACT

Electronic devices, circuitry, and methods are provided for compensating image data to reduce or eliminate image sticking artifacts. Such an electronic device may include an electronic display and image processing circuitry. The image processing circuitry may adjust image data for display on the electronic display to compensate for charge trapping on the electronic display, thereby reducing or eliminating image sticking.

### CROSS-REFERENCE TO RELATED APPLICATIONS

This application claims priority to U.S. Provisional Application No. 63/698,290, filed Sep. 24, 2025, which is incorporated by reference herein in its entirety.

### SUMMARY

The present disclosure relates to compensating image data for display on an electronic display to mitigate image sticking due to charge trapping or detrapping.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices—such as computers, mobile phones, portable media devices, tablets, televisions, virtual-reality headsets, and vehicle dashboards, among many others—often include electronic displays. To display an image, an electronic display may control light emission of its display pixels based on corresponding image data for the display pixels. By emitting light in various gray levels (pixel brightness values) at different display pixels according to the image data, the electronic display may display an image. It is now believed that, over the course of minutes or hours, the trap states of some display pixel circuitry may trap charges based on the image data that is being used to program the display pixels. This may affect the behavior of the display pixel circuitry and, by extension, the amount of light that is emitted by the display pixel. The result is an image sticking artifact that remains faintly visible on the electronic display after the previous image is no longer displayed.

To reduce or eliminate these image sticking artifacts, image data for a target display pixel may be adjusted to compensate for the charge trapping in the display pixel circuitry. For example, as new image data is received for a display pixel, the accumulated change in display pixel behavior over time may be estimated based on the new image data and previous image data for that display pixel due to charge trapping or detrapping in the pixel circuitry of that display pixel. The image data may be adjusted to account for the change in behavior of the display pixel due to the charge trapping or detrapping. For example, if the accumulated change in the behavior of the display pixel due to charge trapping or detrapping results in less light being emitted than desired for the current image data, the image data may be compensated to cause the display pixel to emit more light. As a consequence, when programmed with the compensated image data, the display pixel may emit the proper amount of light. Likewise, if the accumulated change in the behavior of the display pixel due to charge trapping or detrapping results in more light being emitted than desired for the current image data, the image data may be compensated to cause the display pixel to emit less light. As a consequence, when programmed with the compensated image data, the display pixel may emit the proper amount of light.

More specifically, note that the display pixels of the electronic display may be programmed with image data represented by a voltage signal that is applied to a driving transistor on the display pixel. Different voltage levels cause different amounts of current to pass over the driving transistor to a self-emitting pixel element, such as an organic light emitting diode (OLED). The amount of light emitted by the self-emitting pixel element is based on the amount of current. The more current across the self-emitting pixel element, the more light that is emitted. It is believed that, over time, the voltage applied to the gate of the driving transistor may cause trap states of the driving transistor to accumulate charge in a process referred to as charge trapping. Charge trapping may reverse over time in a process referred to as detrapping. The accumulated amount of charge trapping or detrapping may vary depending on the initial state of charge trapping on the driving transistor, the voltage applied to the gate of the driving transistor, and the length of time that the voltage is applied. Charge trapping may affect the threshold voltage (Vth) of the driving transistor, meaning that the same voltage applied to its gate may result in a different amount of current flowing through the driving transistor depending on the amount of charge trapping in the driving transistor.

The amount of compensation for the image data to account for charge trapping or detrapping may be done on a pixel-by-pixel basis and estimated in the voltage domain. That is, the image data may be converted from a gray level value (e.g., representing a normalized level of light that the display pixel is to emit) to a digital voltage value (e.g., representing the voltage that would be programmed into the display pixel to apply to the gate of the driving transistor). Image data from a previous image frame for the display pixel may also be converted from a gray level value to a digital voltage value. These voltage levels may be used to estimate the cumulative effect on the behavior of the display pixel (e.g., based on the change in trap states due to charge trapping or detrapping over time).

An initial correction voltage (Vcorr) may be generated that, when applied to the display pixel, would overcome the effect of charge trapping in the display pixel driving transistor or other display pixel circuitry. For example, a model of the display pixel may be calculated based on parameters stored in a lookup table. The model may be, for example, an exponential or stretched exponential model. The parameters of the lookup table may be populated based on modeled or empirically obtained measurements correlating pixel behavior over time and voltage levels or gray levels and global brightness values. The initial correction voltage (Vcorr) may be determined based on the model. The initial correction voltage (Vcorr) may also be scaled based on the amount of time that has passed and a saturation time, at which point the charge states of the display pixel behavior may be saturated and may no longer change, to produce a final correction voltage (Vcorr). The final correction voltage (Vcorr) may be combined (e.g., added) to the voltage value of the current image data for the display pixel to produce a compensated voltage (Vcomp) that may be converted back into the gray domain as a gray level. The resulting compensated image data (e.g., the resulting gray level) may be used to program the electronic display while reducing or eliminating image sticking artifacts.

Because of the slow timeline charge trapping, which occurs over minutes or hours, the correction voltage (Vcorr) may be recalculated much less frequently than every image frame. For example, there may be 10 frames, 30 frames, 60 frames, 120 frames, 240 frames, or more between recalculating the new correction voltage (Vcorr). In another example, the correction voltage (Vcorr) may be recalculated once per some unit time irrespective of the number of image frames that passes over that time (e.g., once per half-second, once per second, once per 10 seconds, once per minute, once per 5 minutes, and so forth).

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display;

FIG. 2 is a front view of a handheld device representing an example of the electronic device of FIG. 1;

FIG. 3 is a front view of another handheld device representing another example of the electronic device of FIG. 1;

FIG. 4 is a perspective view of a notebook computer representing an example of the electronic device of FIG. 1;

FIG. 5 illustrates front and side views of a wearable electronic device representing another example of the electronic device of FIG. 1;

FIG. 6 is a block diagram of an electronic display that displays image data compensated for image sticking by image sticking compensation circuitry of the electronic device;

FIG. 7 is a block diagram of an electronic display having an array of display pixels controlled by display driver circuitry that includes image sticking compensation circuitry;

FIG. 8 is a flowchart of a method for compensating for image sticking based on accumulated change in pixel behavior due to charge trapping;

FIG. 9 is an illustration of image sticking that may result from an extended stress period on pixels of the electronic display;

FIG. 10 is a plot of luminance variation over time that illustrates image sticking that may result for pixels stressed with white image data and pixels stressed with black image data;

FIG. 11 is a block diagram of the image sticking compensation circuitry;

FIG. 12 is another block diagram of the image sticking compensation circuitry;

FIG. 13 is a diagram of lookup tables storing parameters for a model of charge trapping in the pixels of the electronic display; and

FIG. 14 is a diagram of lookup tables storing saturation times of charge trapping.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

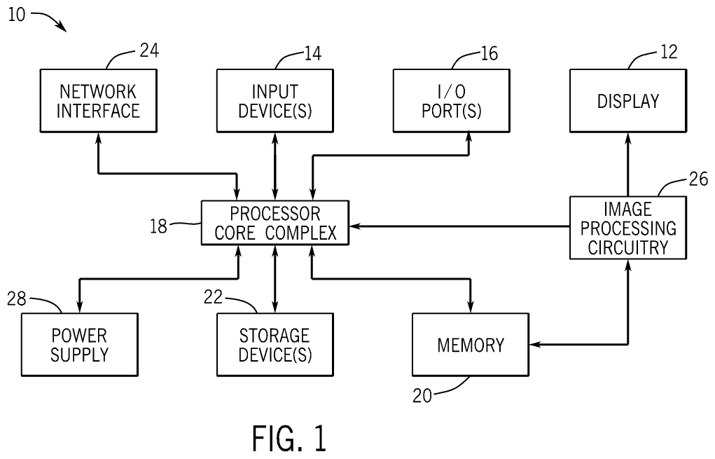

An electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), and image processing circuitry 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include a display panel with an array of display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW pixel arrangement).

The electronic display 12 may display an image by controlling light emission from its display pixels based on image data associated with corresponding display pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

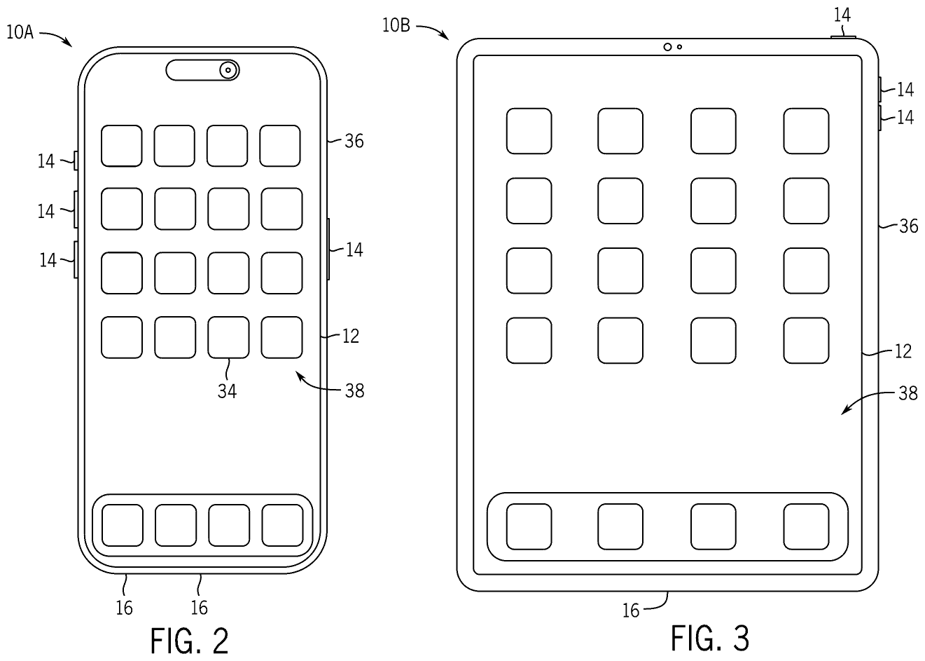

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc.

The handheld device 10A includes an enclosure 36 (e.g., housing). The enclosure 36 may protect interior components from physical damage or shield them from electromagnetic interference, such as by surrounding the electronic display 12. The electronic display 12 may display a graphical user interface (GUI) 38 having an array of icons. When an icon 34 is selected either by an input device 14 or a touch-sensing component of the electronic display 12, an application program may launch.

The input devices 14 may be accessed through openings in the enclosure 36. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

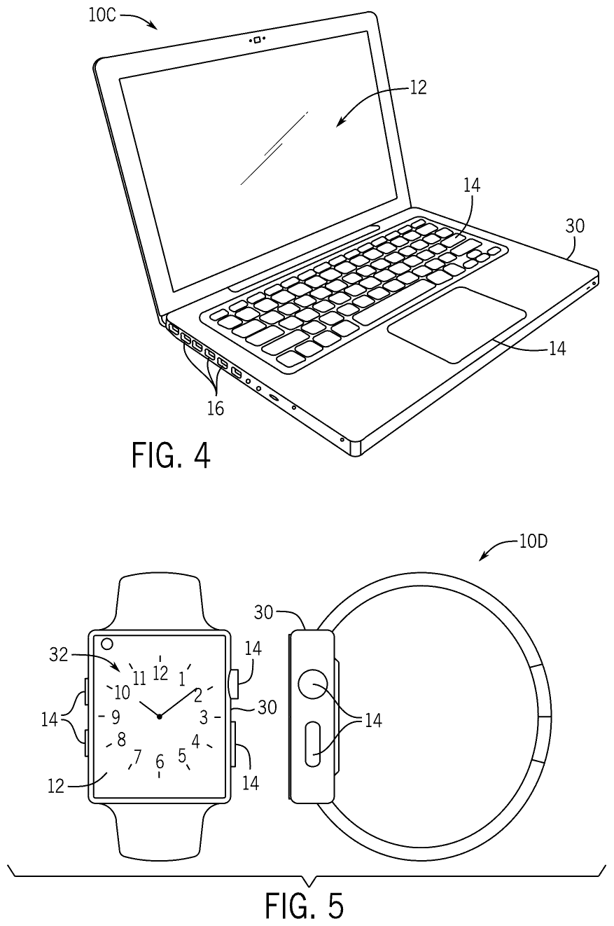

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

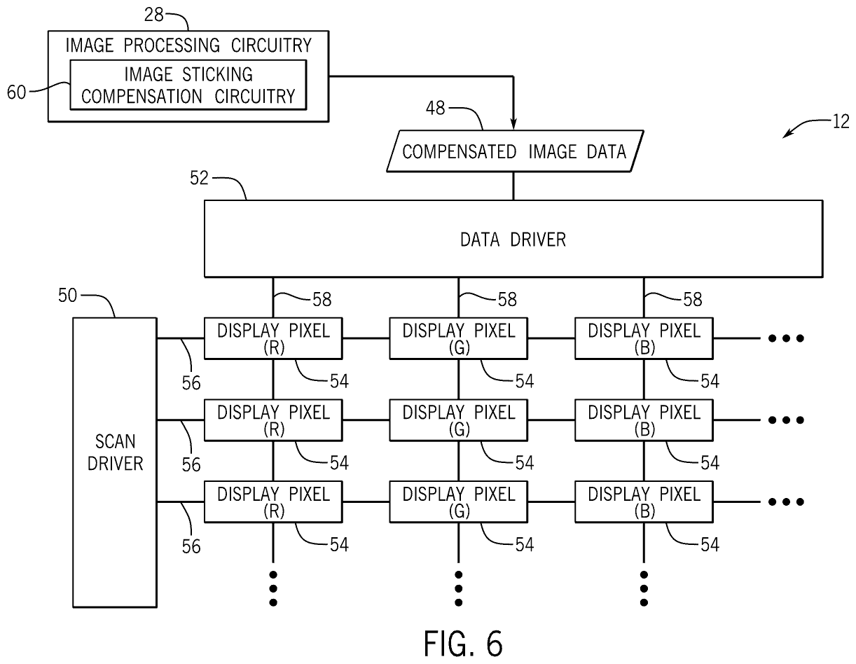

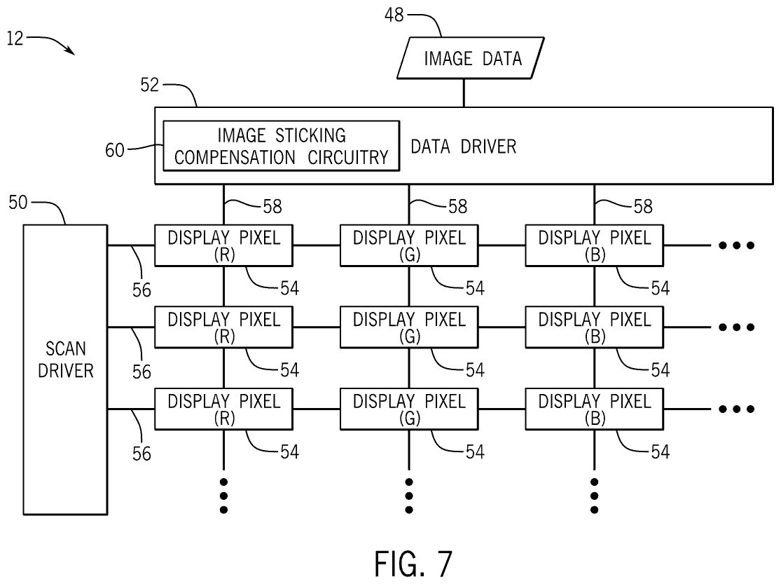

FIGS. 6 and 7 illustrate examples of the electronic display 12. The electronic display 12 may receive image data 48 for display. The electronic display 12 uses display driver circuitry that includes scan driver circuitry 50 and data driver circuitry 52 to program the image data 48 onto display pixels 54. The display pixels 54 may each contain one or more self-emissive elements, such as a light-emitting diodes (LEDs) (e.g., organic light emitting diodes (OLEDs) or micro-LEDs (μLEDs)). Different display pixels 54 may emit different colors (e.g., red (R), green (G), blue (B), for an RGB display). For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress, scan, data sampling) over various scan lines 56. To program the display pixels 54, gate-in-panel circuits of the scan driver 50 may activate the display pixels 54 by row. For example, the scan driver 50 may send a scan signal across a scan line 56 to cause a selected row of the display pixels 54 to become activated. Once activated, the display pixels 54 of that row may receive a portion of the image data 48 provided by the data driver 52 over data lines 58. As used herein, the portion of image data 48 received by display pixels 54 may also be referred to as “pixel data.” The image data may take the form of an analog voltage that is stored into the display pixel 54. The value of the voltage causes the display pixel 54 to emit a certain amount of light. For example, the voltage may be applied to a gate of a driving transistor that provides a current to a self-emissive element (e.g., OLED) based on the voltage. However, as mentioned above, charge trapping or detrapping may cause the pixel circuitry of the display pixels 54 (e.g., driving transistors of the display pixels 54) to change behavior, causing more or less light to be emitted by the display pixels 54 than expected. Over time, this could result in an image sticking artifact.

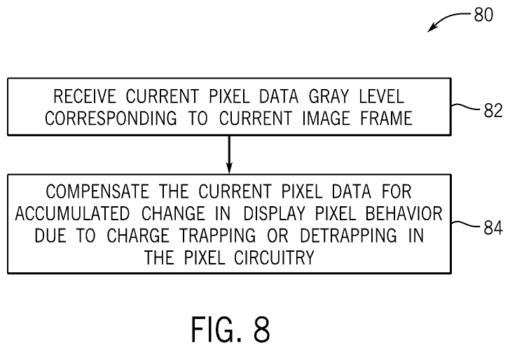

To prevent image sticking, the image processing circuitry 28 (FIG. 6) or the data driver 52 (FIG. 7) may include image sticking compensation circuitry 60. The image sticking compensation circuitry 60 may compensate the image data for the effect of charge trapping in the circuitry of the display pixel 54. For example, as shown in a flowchart 80 of FIG. 8, as new image data is received for a particular display pixel 54 for a current frame (block 82), the image data may be adjusted to account for the change in behavior of the display pixel due to the charge trapping or detrapping since the last different image data was received (block 84). For example, if the accumulated change in the behavior of the display pixel due to charge trapping or detrapping results in less light being emitted than desired for the current image data, the image data may be compensated to cause the display pixel to emit more light. As a consequence, when programmed with the compensated image data, the display pixel may emit the proper amount of light. Likewise, if the accumulated change in the behavior of the display pixel due to charge trapping or detrapping results in more light being emitted than desired for the current image data, the image data may be compensated to cause the display pixel to emit less light. As a consequence, when programmed with the compensated image data, the display pixel may emit the proper amount of light.

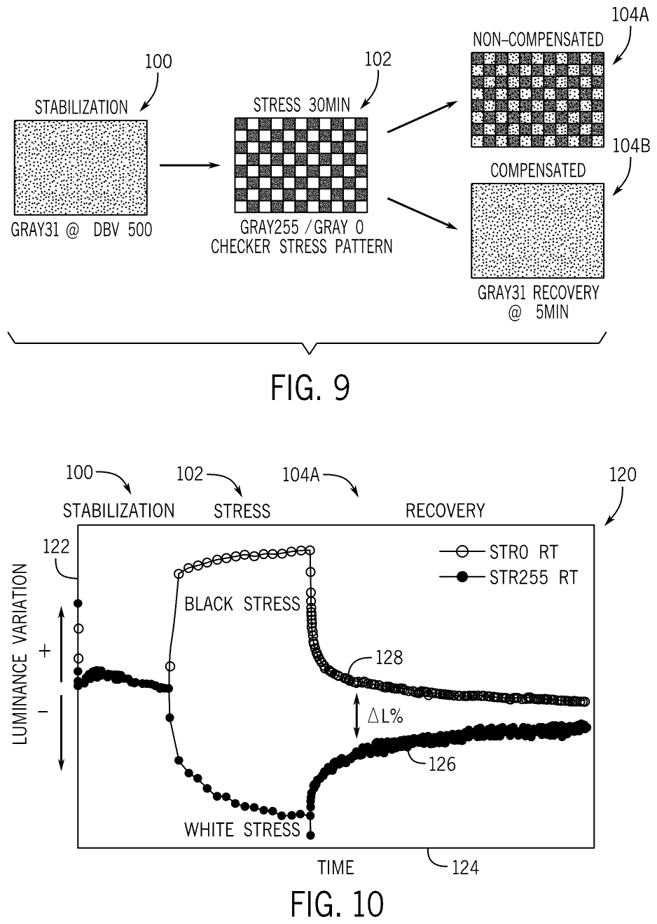

FIG. 9 provides an illustration of image sticking that may appear on the electronic display 12 with and without compensation. The electronic display may initially be in a period of stabilization 100, where the display pixels all behave as expected. Here, all the display pixels are programmed with image data corresponding to the same gray level (here, Gray 31) at a particular global display brightness value (DBV) (here, a DBV500, which represents a middle global display brightness value when there are 1000 different DBV settings). In the initial period of stabilization 100, the electronic display has a uniform appearance. The electronic display may undergo a stress period 102 where image data for one image remains on the electronic display for an extended period of time. Here, a black-and-white checkerboard pattern provides an example of a worst-case scenario with display pixels programmed at the highest or lowest extremes. When represented by 8-bit gray levels, the lowest gray level, Gray 0, is black and the highest gray level, Gray 255, is white. After a period of 30 minutes displaying this image data, when the electronic display is once again programmed with the same gray level as before (here, Gray 31) in a recovery period 104A without compensation, an image sticking artifact remains. But if the image data is compensated in a recovery period 104B for the effect of charge trapping due to the stress period 102, the electronic display has a uniform appearance and the image sticking artifact is not seen on the electronic display.

FIG. 10 is a plot 120 of luminance variation (ordinate 122) over time (abscissa 124) when the image data is not compensated for image sticking. A curve 126 illustrates a change in luminance (light emission) behavior of display pixels stressed with white (Gray 255) image data and a curve 128 illustrates a change in luminance behavior of display pixels stressed with white (Gray 255) image data over time. The curves 126 and 128 begin the same at a baseline value of no luminance change. Throughout the stabilization period 100, the curves 126 and 128 do fluctuate (e.g., here, the luminance initially increases before returning to baseline), but the curves 126 and 128 are the same. This means that throughout the stabilization period 100, the luminance of the electronic display 12 appears to be uniform when viewed.

In the stress period 102, display pixels that are programmed with black (Gray 0) may receive image data corresponding to a very negative voltage. Meanwhile, display pixels that are programmed with white (Gray 255) may receive image data corresponding to a very positive voltage. This may result in charge opposite effects of trapping that changes the behavior of the display pixels. For example, display pixels that receive the black (Gray 0) voltage may experience charge trapping or detrapping that, over time, results in slightly higher light output than programmed. At the same time, however, display pixels that receive the white (Gray 255) voltage may experience charge trapping or detrapping that, over time, results in slightly higher light output than programmed.

Without compensation, in the recovery period 104A, some of the luminance variation may persist. Thus, even though all the display pixels of the electronic display may be programmed with the same image data (e.g., Gray 31), a luminance variation (ΔL%) here may remain. The effect is seen by a viewer of the electronic display as a lingering ghost image of image from the stress period 102.

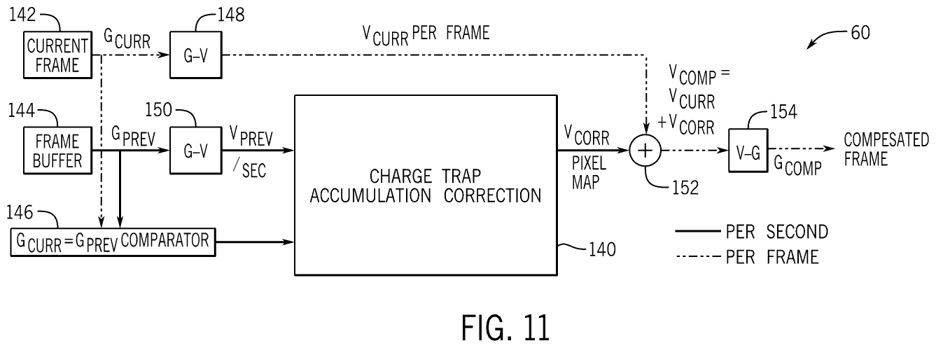

FIG. 11 is a block diagram of one example of the image sticking compensation circuitry 60. The image sticking compensation circuitry 60 may include charge trap accumulation correction circuitry 140 to compensate image data before it is displayed on the electronic display to counteract the effects of luminance variation. The charge trap accumulation correction circuitry 140 may compute a correction based on a model of the state of each display pixel based on the current and previous image data that is to be displayed on the electronic display. As discussed above, based on the amount of time that different image data is displayed on each display pixel, charge trapping in each display pixel may have a different effect on the display pixel luminance variation. Thus, the charge trap accumulation correction circuitry 140 may compute the correction to compensate the image data pixel by pixel.

Before continuing, recall that charge trapping has a relatively slow timeline, occurring over minutes or hours, compared to the generation of new image frames, which often occurs many times per second (e.g., at a rate of 10 Hz, 24 Hz, 30 Hz, 60 Hz, 120 Hz, or 240 Hz, or higher). As such, the image sticking compensation circuitry 60 may calculate a compensation to be applied to the image data to be displayed on the electronic display at a lower frequency than the frame rate of image data to be displayed on the electronic display. For example, the image sticking compensation circuitry 60 may recalculate the compensation once per some unit time irrespective of the number of image frames that passes over that time (e.g., once per half-second, once per second, once per 10 seconds, once per minute, once per 5 minutes, and so forth). In the example of FIG. 11, the image sticking compensation circuitry 60 computes a new compensation to apply to the image data once per second, whereas new image frames of the image data may be received and compensated using that compensation at any suitable frame rate (e.g., 10 Hz, 24 Hz, 30 Hz, 60 Hz, 120 Hz, or 240 Hz, or higher).

For each pixel, the image sticking compensation circuitry 60 may receive current image data (G_{curr}) corresponding to a current frame 142 of image data and previous image data (Gₚᵣₑᵥ) corresponding to a previous frame from a framebuffer 144. A comparator 146 may determine whether the current image data (G_{curr}) is equal to, greater than, or less than the previous image data (Gₚᵣₑᵥ). This may indicate whether the display pixel to which current image data (G_{curr}) is intended is undergoing a period of charge trapping or detrapping.

Since the charge trapping and detrapping phenomenon of the amount of voltage applied to the circuitry of the display pixel, the compensation that is to be applied to the image data may be calculated in the voltage domain. Thus, the image data may be converted from a digital value in the gray domain (e.g., gray level) into a digital value in the voltage domain (e.g., the corresponding value of voltage). The current image data (G_{curr}) may be converted to an equivalent digital value of current image data voltage (V_{curr}) in gray-to-voltage conversion circuitry 148. The previous image data (Gₚᵣₑᵥ) may be converted to an equivalent digital value of previous image data voltage (Vₚᵣₑᵥ) in gray-to-voltage conversion circuitry 150. The gray-to-voltage conversion circuitry 148 and 150 may transform the image data in the gray domain to the voltage domain using any suitable computation. In some cases, the gray-to-voltage conversion circuitry 148 and 150 may also account for a global display brightness value (DBV) level at which the image data is to be displayed. The global display brightness value (DBV) level may be an overall brightness setting of the entire display. For example, the global display brightness value (DBV) level may be set by a user in a graphical user interface (GUI) of the electronic device. Setting the global display brightness value (DBV) level higher may make the electronic display brighter, while setting the global display brightness value (DBV) level lower may make the electronic display darker. The gray-to-voltage conversion circuitry 148 and 150 may be formed using a lookup table (LUT) indexed to gray level (and, in some cases, the global display brightness value (DBV)) to obtain the current image data voltage (V_{curr}) and the previous image data voltage (Vₚᵣₑᵥ).

The charge trap accumulation correction circuitry 140 may use the previous image data voltage (Vₚᵣₑᵥ) and the comparison of the current image data (G_{curr}) and the previous image data (Gₚᵣₑᵥ) to estimate a cumulative effect of charge trapping on the corresponding display pixel. In one example, the cumulative effect of charge trapping may be understood to affect the threshold voltage (Vₜₕ) of the driving transistor of the display pixel. As such, the charge trap accumulation correction circuitry 140 may calculate a correction voltage (V_{corr}) to account for a change in the threshold voltage (Vₜₕ) of the driving transistor based on the amount of charge trapping and detrapping that is modeled to be present in the display pixel. The correction voltage (V_{corr}) may be stored in a pixel map in memory and added in an adder 152 to the current image data voltage (V_{curr}) to obtain a compensated current image data voltage (V_{comp}) value. Voltage-to-gray conversion circuitry 154 may operate in a reverse manner to the gray-to-voltage conversion circuitry 148 and 150 (e.g., using a lookup table (LUT)). The voltage-to-gray conversion circuitry 154 may transform the compensated current image data voltage (V_{comp}) value from the voltage domain back into the gray domain to obtain compensated current image data (G_{comp}). The compensated current image data (G_{comp}) thus forms part of a compensated frame of image data that is programmed into the electronic display. The compensated current image data (G_{comp}), when programmed into its corresponding display pixel, may exhibit reduced luminance variation due to charge trapping. This may reduce or eliminate image sticking artifacts on the electronic display.

As mentioned above, the correction voltage (V_{corr}) may be calculated less frequently than the frame rate of new image data prepared for display on the electronic display. As such, for image data received when the correction voltage (V_{corr}) is not recalculated, which may be for most new image data, the previously calculated correction voltage (V_{corr}) may be retrieved from the pixel map in memory and added to the current image data voltage (V_{curr}) to obtain the compensated current image data voltage (V_{comp}) value.

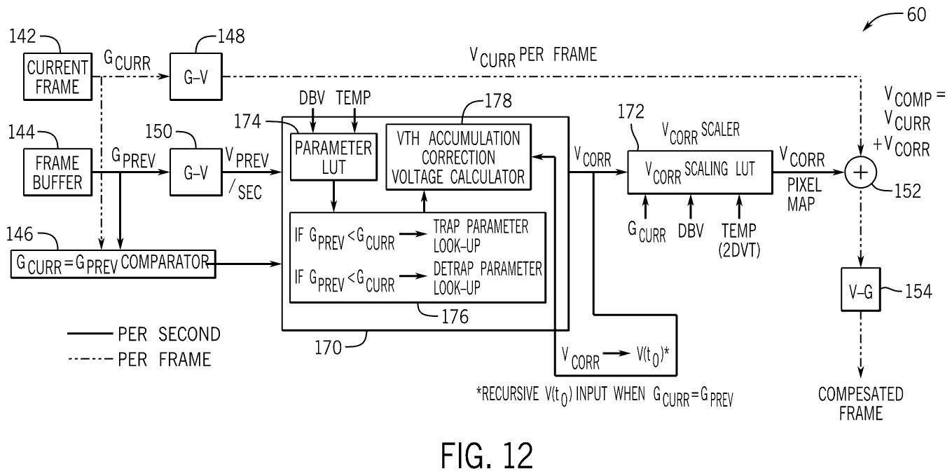

FIG. 12 illustrates a block diagram of the image sticking compensation circuitry 60 with an example implementation of the charge trap accumulation correction circuitry 140. For a description of elements of FIG. 12 that also appear in FIG. 11, please see the discussion in relation to FIG. 11 above. As seen in FIG. 12, the charge trap accumulation correction circuitry 140 may include threshold voltage (Vₜₕ) compensation circuitry 170 and a correction voltage (V_{corr}) scaler 172. The threshold voltage (Vₜₕ) compensation circuitry 170 may model the effect of charge trapping and detrapping due to the current and previous image data and output an initial version of the correction voltage (V_{corr}). The threshold voltage (Vₜₕ) accumulator operation of the threshold voltage (Vₜₕ) compensation circuitry 170 may be modeled using any model with any suitable parameters. For example, a model of the display pixel may be, for example, an exponential or stretched exponential model. The parameters of the model may be based on precalculated computer modeling of the display pixel behavior and/or empirically obtained measurements of the electronic display (e.g., a prototype or example electronic display out of a batch of electronic displays that are manufactured) correlating pixel behavior over time and voltage levels or gray levels and global brightness values. In one example, the threshold voltage (Vₜₕ) compensation circuitry 170 may use a stretched exponential model with three parameters: the final threshold voltage (Vₜₕ) value after saturation, a time constant, and a stretched exponential factor.

The parameters of the model relating to threshold voltage (Vₜₕ) due to charge trapping and detrapping may be retrieved from a parameter lookup table (LUT) 174. The parameter LUT 174 may store different sets of parameters based on whether charge trapping or charge detrapping is taking place. The parameters of the parameter lookup table (LUT) 174 may also take into account a present global display brightness value (DBV) and temperature of the display pixel. Parameter selection circuitry 176 may retrieve charge trap parameters from the parameter LUT 174 when the previous image data (Gₚᵣₑᵥ) is less than the current image data (G_{curr}). The parameter selection circuitry 176 may retrieve charge detrap parameters from the parameter LUT 174 when the previous image data (Gₚᵣₑᵥ) is greater than the current image data (G_{curr}). The parameters may be used in a threshold voltage (Vₜₕ) accumulation correction voltage calculator 178. The presently calculated correction voltage (V_{corr}) may be determined based on the final threshold voltage (Vₜₕ) value after saturation, adjusted according to the other model parameters, the time elapsed since different image data was received for the display pixel, and the original correction voltage (V_{corr}) that was calculated when the different image data was received for the display pixel (e.g., referred to as V(t₀)). In one example, the presently calculated correction voltage (V_{corr}) may be equal to the final threshold voltage (Vₜₕ) value after saturation, plus a difference value that is scaled based on the model of the display pixel (e.g., a natural exponential decay function based on the time elapsed, the time constant, and the stretched exponential factor). The difference value may equal the difference between the originally calculated correction voltage (V(t₀)) and the final threshold voltage (Vₜₕ) value after saturation.

The resulting presently calculated correction voltage (V_{corr}) may be scaled based on the long-term final saturation time using a correction voltage scaling lookup table (LUT) of the correction voltage (V_{corr}) scaler 172. For example, based on the current image data (G_{curr}), the present global display brightness value (DBV), and the temperature of the display pixel, the correction voltage (V_{corr}) may be scaled linearly to diminish the strength of the compensation. For instance, the scaled correction voltage (V_{corr}) may be equal to the initial correction voltage (V_{corr}) multiplied by a scaling value. The scaling value may be equal to 1 minus the ratio of the elapsed time (e.g., since the last change in image data when the different image data was received for the display pixel) to the final saturation time. The resulting scaled correction voltage (V_{corr}) may be stored in the pixel map in memory and added in the adder 152 to the current image data voltage (V_{curr}) to obtain the compensated current image data voltage (V_{comp}) value. The voltage-to-gray conversion circuitry 154 may transform the compensated current image data voltage (V_{comp}) value from the voltage domain back into the gray domain to obtain compensated current image data (G_{comp}). The compensated current image data (G_{comp}), when programmed into its corresponding display pixel, may exhibit reduced luminance variation due to charge trapping. This may reduce or eliminate image sticking artifacts on the electronic display.

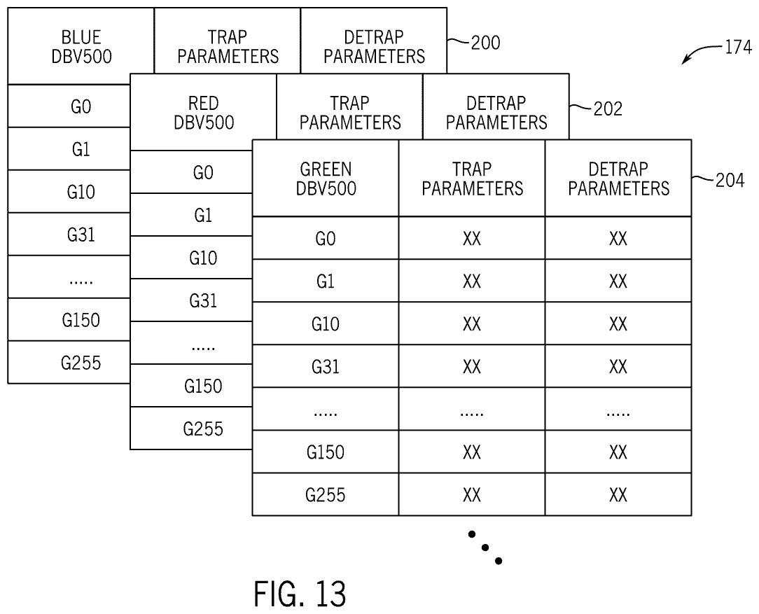

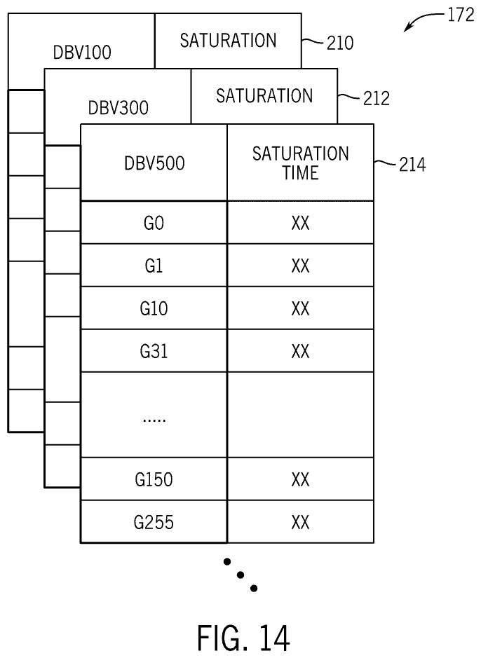

FIGS. 13 and 14 illustrate examples of information that may be stored in the parameter LUT 174 and the correction voltage (V_{corr}) scaling lookup table (LUT) of the correction voltage (V_{corr}) scaler 172, respectively. It should be appreciated that these FIGS. are meant to illustrate the type of information that may be included and are not intended to be exhaustive. As shown in FIG. 13, the parameter LUT 174 may include numerous sub-tables 200, 202, 204, and so on for different values of global display brightness value (DBV), temperature, and/or pixel color (e.g., red, green, or blue). Depending on the current gray level and/or gray level difference between the current gray level and the previous gray level, the trap parameters or detrap parameters may be selected to model the effect of charge trapping on the display pixel circuitry. As mentioned above, the trap parameters or detrap parameters may include a final threshold voltage (Vₜₕ) value after saturation, a time constant, and a stretched exponential factor. As should be appreciated, if a different model is used, the parameter LUT 174 may store different parameters.

As shown in FIG. 14, the correction voltage (V_{corr}) scaling lookup table (LUT) of the correction voltage (V_{corr}) scaler 172 may also include numerous sub-tables 210, 212, 214, and so on for different values of global display brightness value (DBV), temperature, and/or pixel color (e.g., red, green, or blue). In this way, the correction voltage (V_{corr}) scaling lookup table (LUT) of the correction voltage (V_{corr}) scaler 172 may indicate the final saturation time associated with charge trapping given the present conditions on the display pixel.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising:
an electronic display; and
image processing circuitry configured to adjust image data for display on the electronic display to compensate for charge trapping or detrapping on the electronic display based on a charge trapping model having a first parameter relating to charge trapping or detrapping saturation time.

2. The electronic device of claim 1, wherein the image processing circuitry is configured to determine the adjustment at a rate different than a frame rate of the image data.

3. The electronic device of claim 2, wherein the rate is slower than the frame rate of the image data.

4. The electronic device of claim 1, wherein the image processing circuitry is configured to adjust the image data in a voltage domain.

5. The electronic device of claim 1, wherein the image processing circuitry is configured to adjust the image data based on differences between image frames using the charge trapping model.

6. The electronic device of claim 5, wherein the image processing circuitry is configured to apply a set of charge trapping parameters in the charge trapping model when current image data is less than previous image data and apply a set of charge detrapping parameters in the charge trapping model when the current image data is greater than the previous image data.

7. The electronic device of claim 1, wherein the image processing circuitry is configured to adjust the image data based on a previously determined adjustment to the image data.

8. The electronic device of claim 1, wherein the image processing circuitry is configured to obtain a first correction to the image data and scale the first correction to the image data based on the saturation time of the charge trapping or detrapping of a display pixel of the electronic display.

9. Image processing circuitry comprising:
a frame buffer configured to store previous image data from a previous frame of image data;
comparison circuitry configured to compare the previous image data with current image data from a current frame of image data;
correction circuitry configured to determine image data correction values corresponding to display pixels of an electronic display, based on the comparison of the previous image data with the current image data, to compensate for image sticking artifacts on the electronic display due to charge trapping or detrapping; and
addition circuitry to add the image data correction values to the current image data to obtain image data compensated for the image sticking artifacts when displayed on the electronic display.

10. The image processing circuitry of claim 9, comprising gray-to-voltage transformation circuitry configured to convert the previous image data and the current image data into a voltage domain, wherein the correction circuitry is configured to determine the image data correction values in the voltage domain.

11. The image processing circuitry of claim 9, comprising memory configured to store a pixel map of the image data correction values to enable correction of future current image data of a future frame of image data without recalculating the image data correction values.

12. The image processing circuitry of claim 9, wherein the correction circuitry comprises:
a parameter lookup table configured to store parameters of a model of charge trapping or detrapping; and
threshold voltage (Vₜₕ) accumulation correction voltage calculation circuitry configured to determine the image data correction values based on the model of charge trapping or detrapping.

13. The image processing circuitry of claim 12, comprising parameter selection circuitry configured to retrieve different parameters from the parameter lookup table based on the comparison of the previous image data with the current image data.

14. The image processing circuitry of claim 13, wherein the parameter selection circuitry is configured to select between charge trap parameters or charge detrap parameters from the parameter lookup table based on the comparison of the previous image data with the current image data.

15. The image processing circuitry of claim 12, wherein the correction circuitry comprises a correction value scaling lookup table configured to store scaling values to scale the image data correction values based on a final saturation time of the model of charge trapping or detrapping.

16. A method comprising:
receiving current pixel data corresponding to a display pixel on an electronic display and previous pixel data corresponding to the display pixel; and
compensating the current pixel data for accumulated change in a behavior of the display pixel due to charge trapping or detrapping in pixel circuitry of the display pixel, based on a difference between the current pixel data and the previous pixel data.

17. The method of claim 16, wherein compensating the current pixel data comprises adjusting the current pixel data to increase display pixel luminance when the accumulated change in the behavior of the display pixel due to charge trapping or detrapping causes the display pixel to emit less light.

18. The method of claim 16, wherein compensating the current pixel data comprises adjusting the current pixel data to decrease display pixel luminance when the accumulated change in the behavior of the display pixel due to charge trapping or detrapping causes the display pixel to emit more light.

19. The method of claim 16, wherein the compensation is performed in a voltage domain.

20. The method of claim 16, wherein the compensation is based on an exponential model of the charge trapping or detrapping in the pixel circuitry of the display pixel.

21. The method of claim 16, wherein compensating the current pixel data comprises computing a correction value and scaling the correction value based on a final saturation time of the charge trapping or detrapping in the pixel circuitry of the display pixel.
